(19) United States
(12) Patent Application Publication
(10) Pub. No.: US 2012/0195825 A1
(43) Pub. Date: Aug. 2, 2012

(54) Hydrogen Generator and Method of Operating It

(76) Inventors: Arthur Koschany, Singapore (SG); Zhijun Gu, Shanghai (CN)

(21) Appl. No.: 13/101,748

(22) Filed: May 5, 2011

(30) Foreign Application Priority Data
Feb. 1, 2011 (SG) 201100904-0

(51) Int. Cl. C01B 3/06; G01N 1/00; G05D 23/00; B01J 8/02

(52) U.S. Cl. 423/657; 422/211; 422/119; 422/109

(57) ABSTRACT

A hydrogen generator working by hydrolysis of the metal borohydride is described comprising a reaction chamber (7) which in its bottom part has a liquid collecting area (30) and leads by short and non-complex connecting components to a conduit end (38) through which the exhaust products (31) of the reaction are discharged into the environment, generally the atmosphere and thereby saving weight and volume. By using given high pressures and temperatures for the reaction, the danger of crystallization of exhaust products is prevented.

### FIELD OF THE INVENTION

The invention relates to a hydrogen generator which can be a hydrogen generator comprising a container for containing an aqueous solution of at least one metal hydride, a reactor chamber containing a catalyst, a pump for pumping the aqueous solution from the container to the reactor chamber, a first liquid collecting area communicating with the reactor chamber for collecting the reaction exhaust products, an exhaust products outlet exiting from the collecting area and a gas outlet for extracting the gaseous products, or a hydrogen generator comprising a container for containing a liquid reaction agent, a reactor chamber containing at least one metal hydride in solid form, a pump for pumping the liquid reaction agent from the container to the reactor chamber, a first liquid collecting area communicating with the reactor chamber for collecting the reaction exhaust products, an exhaust products outlet exiting from the collecting area and a gas outlet for extracting the gaseous products, and to a method of operating it.

### BACKGROUND OF THE INVENTION

Hydrogen generators of the kind mentioned above usually serve to supply fuel cells with gaseous hydrogen, e.g. for vehicles such as small aircrafts. Particularly for this purpose low volume and light weight are essential. Hydrogen is chemically generated by a following reaction

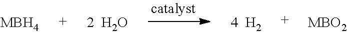

where MBH₄ and MBO₂ respectively represent a metal borohydride and a metal metaborate. While H₂ is the useful product, MBO₂ and residual water, partly in the form of steam, are exhaust products. These exhaust products, dissolved in aqueous solution, have a high tendency to crystallize.

According to US 2004/0009379 A1 the exhaust product is separated into dry residuals which are collected in a special vessel, and steam which can be vented to the atmosphere. The drying equipment and the mentioned vessel lead to a bulky and heavy construction.

According to US 2006/0225350 A1, the exhaust is processed in a gas/liquid separator and the exhaust is drained to a collecting tank. Again, the construction is unfavourable with respect to size and weight. This prior art, further, uses a closed loop control of the pressure and the temperature in the reaction chamber, mentioned pressures are from 0 to 41 kPa and mentioned temperatures are 20 to 50° C.

Due to U.S. Pat. No. 7,083,657 B2, the exhaust product is separated into its gaseous and liquid components, the liquid component being fed back to the reaction chamber. In this prior art, the problem is further discussed that in the reaction exhaust products the salt product tends to crystallize, thereby clogging the reaction chamber or the downstream conduits and apparatus.

### SUMMARY OF THE INVENTION

It is an object of the invention to provide for a compact, lightweight hydrogen generator. For such compact generators with small sized element, it is particularly necessary to avoid crystallization of the reaction exhaust products which, in this case hypercritically congests the conduits. For preventing the crystallization, the conduit extending from the exhaust products outlet via the controllable valve to a conduit end carries heating devices at least along part of its length, an elevated temperature counteracts the crystallization.

To obtain such compact and lightweight generator, according to the invention, in the generator the exhaust products outlet opens to the environment via a controllable valve. By such disposals, the components for separating or drying the exhaust products are no longer necessary.

A further aspect with reference to the compactness is the fact that the saturation water vapour partial pressure depends on the temperature but keeps materially constant if the gas pressure of the mixture containing the water vapour in the reaction chamber is increased. Upon hydrolyses, it is possible to generate the hydrogen under a high pressure in the reaction chamber by controlling the flow rate of the pump and the power of heating devices of the reaction chamber, where a preferred temperature is at least 70° C. For this reason, the reactor chamber preferably contains temperature and pressure sensors, it is coupled to temperature adjusting devices, and the sensors are connected to a control unit controlling the pump and the temperature adjusting devices.

For maintaining the desired pressure in the reaction chamber the first liquid collecting area contains first liquid level sensors coupled to a control unit controlling the controllable valve which opens and closes in intervals.

In the generator the gas outlet is coupled via a cooling device to a gas/liquid separator containing a second liquid collecting area including second liquid level sensors, as is known in the prior art; To said area a discharging conduit is connected which leads via a controllable valve, which opens and closes in intervals, alternatively to the environment or to a point upstream of the pump. The liquid is almost pure water which, if conducted to the environment, is discharged similarly as the reaction exhaust products, and if conducted to a point upstream of the pump, can be used for diluting the fuel, similarly to the prior art U.S. Pat. No. 7,083,657 B2, or for a cleaning cycle

For avoiding crystallization of the reaction exhaust products in the reaction chamber and its downstream elements, high pressure and high temperature according to mutual relations are preferably used, as characterized in claims 9 to 11.

### BRIEF DESCRIPTION OF THE DRAWINGS

The foregoing and further objects, features and advantages of the present invention will become apparent from the following description of preferred embodiments with reference to the accompanying drawings.

FIG. 1 shows an embodiment of the hydrogen generator of the invention

FIG. 2 shows a section view of an alternative embodiment of the invention

FIG. 3 shows a section view of another alternative embodiment of the invention

FIG. 4 shows a graph of the correlation between pressure and temperature

### DETAILED DESCRIPTION OF PREFERRED EMBODIMENTS

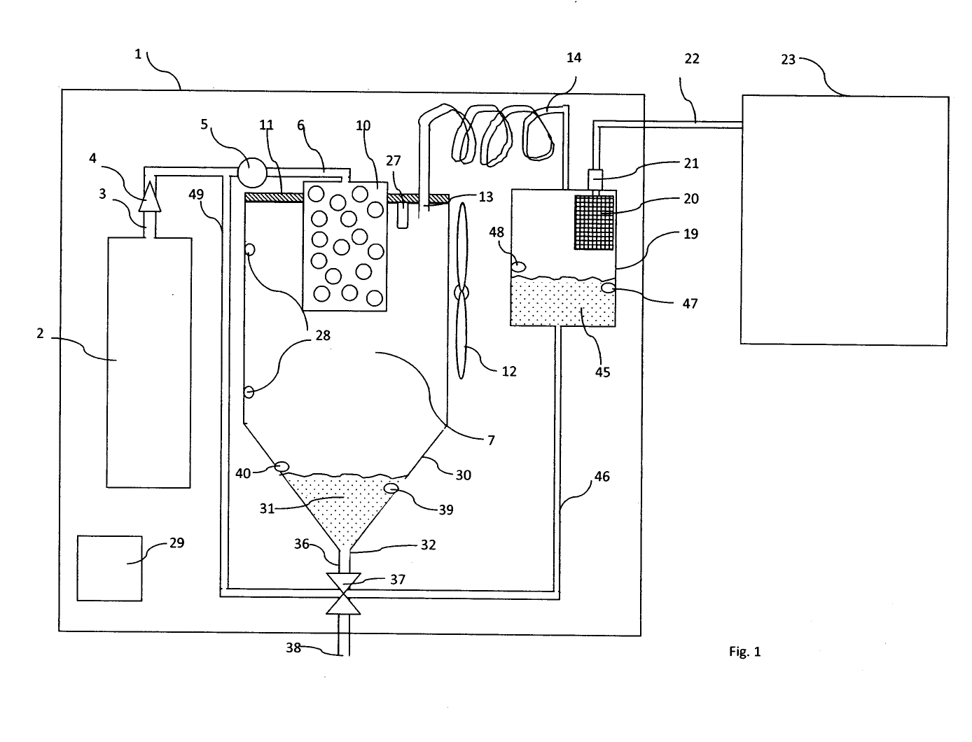

A hydrogen generator 1 according to FIG. 1 comprises a bag shaped fuel container 2 that contains an aqueous solution of a metal hydride, in the present example sodium borohydride, which via a conduit 3 and a check valve 4 is conducted to a pump 5, here a peristaltic pump, which pumps the solution under pressure via a conduit 6 to a reaction chamber 7. Contained in the reaction chamber is a fixed bed catalyst device 10, e.g. consisting of porous ceramic substrates with a supported catalyst of known kind. An alternative catalyst device, not shown, consists of movable catalyst supports to be immersed into the solution in the reaction chamber. The reaction chamber can be heated by a heater 11 and can be cooled by fans 12. According to alternatives not shown, the heater 11 and the cooling fans 12 can be replaced by heat pipes. In the reaction chamber, the reaction mentioned above takes place, releasing hydrogen and reaction exhaust products.

The hydrogen escapes the reaction chamber through a gas outlet 13, flows through a cooling coil 14 and is fed into a gas/liquid separator 19. In this separator, the hydrogen is withdrawn through filter units 20 and a pressure regulator 21 and fed via a conduit 22 to a fuel cell system 23.

The reaction chamber 7 contains a pressure sensor 27 and temperature sensors 28. A control unit 29 in the hydrogen generator 1 picks up the values of the pressure sensor 27 and the temperature sensors 28 and regulates the flow rate of the pump 5 as well as the power of the heater 11 and of the fans 12 according to a given program.

In the lower part of the reaction chamber 7 there is a first liquid collecting area 30 wherein the slurry like exhaust products 31 accumulate. An exhaust products outlet 32 at the bottom of area 30 extends to a conduit 36 and further via a controllable valve 37 to a conduit end 38 that is located outside the casing of the hydrogen generator 1. In area 30 two liquid level sensors 39, 40 are arranged at slightly different level heights and are connected to the control unit 29, which controls the valve 37. When the higher liquid level sensor 40 gives a signal, the control unit 29 opens the valve 37 between conduit 36 and conduit end 38, discharging the exhaust products 31 through end 38 into the surrounding environment. As surrounding environment the atmosphere is usually defined; also the surrounding environment can be a collection container open to atmosphere, that is no part of the hydrogen generator and not shown in the figures, wherein the exhaust products are accumulated. When the lower liquid level sensor 39 gives a signal, the control unit 29 closes the valve 37. To maintain the predefined pressure in the reaction chamber 7 the level difference between the sensors 39,40 is small as well as the discharged amount, keeping the gas volume in chamber 7 almost constant. The frequency of opening the valve 37 is rather high and the duty rate can be in the order of 1:10. The path from the outlet 32 to the conduit end 38 is short and does not contain complex elements, thereby almost preventing the danger of crystallization. As a further measure the conduit 36 and the valve 37 are at least partially heated.

In the lower part of gas/liquid separator 19, the water condensed from the mixture of hydrogen and steam and cooled in the cooling coil 14 accumulates in a second liquid collecting area 45. In the bottom of area 45, a discharging conduit 46 is connected that leads to the valve 37. Two level sensors 47, 48 are placed in the area 45 and connected to the control unit 29, working similar to level sensors 39, 40. The valve 37, controlled by control unit 29, can block the exit of the liquid through the discharging conduit 46, can connect the discharging conduit 46 to the conduit end 38 so as to discharge the condensed water or can connect the discharging conduit 46 to a conduit 49, located to a point upstream of the pump 5 either into the fuel container 2 or directly into pump 5. The latter can be suitable for a cleaning cycle for restarting the generator after an interruption, thus preventing clogging of the system by crystallization; or for diluting the solution of the metal hydride.

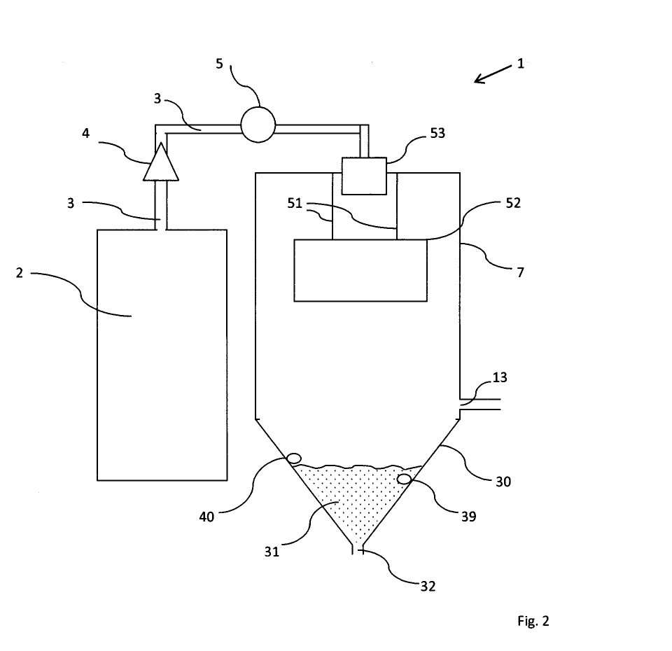

According to different embodiment shown in FIG. 2, located directly in the reaction chamber 7 and fixed by fixing devices 51 there is a solid block 52 of a chemical hydride. A reaction agent in the fuel container 2 that is an aqueous acidic solution such as phosphoric acid to which possibly a catalyst is added, is transported via the conduit 3 to the check valve 4 and pump 5 and further to a distributer 53, that is located at the top of reacting chamber 7 and arranged to spray the reaction agent to the solid block 52 thereby originating the reaction. The gas outlet 13 in this embodiment is situated near the bottom of the chamber 7, but above the liquid collecting area 30 as in the embodiment of FIG. 1.

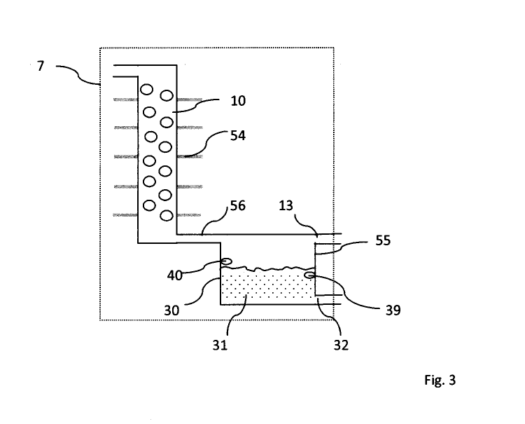

FIG. 3 shows a still different constellation of the reaction chamber 7, which is supplied by the fuel solution of FIG. 1 and is equipped with the fixed bed catalyst device 10 and comprises cooling rips 54, and the liquid collecting area 30 is constructed as a separate container 55 connected to the catalyst device 10 by a tube 56. The gas outlet 13 is arranged in the top part of the container 55, and the exhaust products outlet at the lower part of the container 55 at a level lower than the lower level sensor 39.

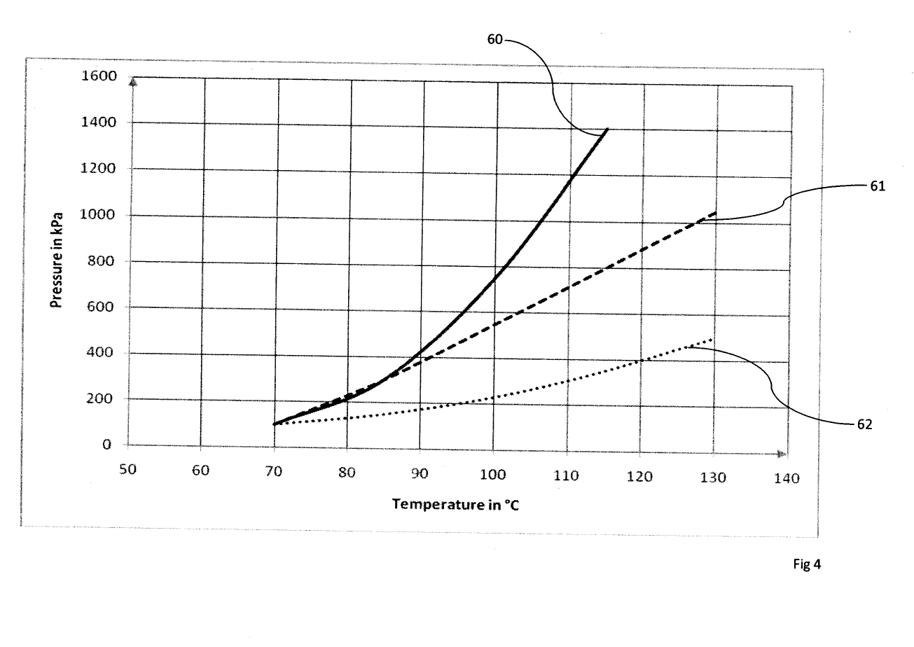

In the graph of FIG. 4, the pressure in kPa at the ordinate is plotted against the temperature in ° C. at the abscissa. Three curves 60, 61, 62 show limits of the correlation between pressure and temperature. Curve 60 shows generally the temperature limit dependent on the pressure, in the area left of curve 60 (lower temperatures) the danger of crystallization is too high. Curve 61 and 62, referring to the embodiment of FIG. 1, show limits of the correlation of pressure and temperature for different concentrations of sodium borohydride in water, i.e. curve 61 for a 25% and curve 62 for a 20% solution, wherein for both cases the operating points should be selected between curve 60 and curve 61 or respectively 62 for obtaining optimal conditions to avoid crystallization of the exhaust products. These curves appear in the tables of claims 10 to 12.

1-14. (canceled)

15. A hydrogen generator (1) which produces hydrogen gas products and reaction exhaust products comprising
a container (2) for containing an aqueous solution of at least one metal hydride;
a pump (5) connected to said container, said pump being used to pump the aqueous solution out of said container;
a reaction chamber (7) containing a catalyst (10), said chamber being connected to said pump and being designed to receive the aqueous solution from said pump;
a first liquid collecting area (30) communicating with said reactor chamber for collecting reaction exhaust products (31);
a gas outlet (13) connected to said reaction chamber for extracting gaseous products;
an exhaust products outlet (32) connected to and exiting from said collecting area; and
a controllable valve (37) connected to said exhaust products outlet, said controllable valve opening into the environment.

16. The generator of claim 15, further comprising temperature sensors (28) and a pressure sensor (27) located in said reaction chamber (7).

17. The generator of claim 16 further comprising
heating means (11) for heating said reaction chamber; and
cooling means (12) for cooling said reaction chamber.

18. The generator of claim 17 further comprising a control unit (29) connected to said pressure sensor (27) and said temperature sensors (28), said control unit controlling said pump (5), said heating means and said cooling means.

19. The generator of claim 18 further comprising first liquid level sensors (39, 40) contained within said collecting area (30), said level sensors being controlled by said control unit (29) which control unit also controls said controllable valve (37).

20. The generator of claim 19 further comprising an at least partially heated conduit (36) extending from said exhaust products outlet (32) through said controllable valve (37) to a conduit end (28) located outside of the hydrogen generator.

21. The generator of claim 20 further comprising
a cooling device (14) connected at an entry point to said gas outlet (13);
a gas/liquid separator (19) connected to an exit point of said cooling device;
a second liquid collecting area (45) enclosed within said gas/liquid separator;
second liquid level sensors (47, 48) located within said second liquid collecting area; and
a discharging conduit (46) connected at one end to said second liquid collecting area and at the other end optionally either to said controllable valve (37) or to a point between said container (2) and said pump (5).

22. The generator of claim 15 wherein said controllable valve (37) opens into a container for accumulating said reaction exhaust products (31) which container itself opens into the environment.

23. A hydrogen generator (1) which produces hydrogen gas products and reaction exhaust products comprising
a container (2) containing a liquid reaction agent;
a pump (5);
a reaction chamber (7) containing at least one metal hydride in solid form (52);
a conduit (3) connecting said container and said reaction chamber to said pump;
a first liquid collecting area (30) communicating with said reactor chamber for collecting the reaction exhaust products (31);
a gas outlet (13) connected to said reaction chamber for extracting gaseous products;
an exhaust products outlet (32) connected to and exiting from said collecting area; and
a controllable valve (37) connected to said exhaust products outlet, said controllable valve opening into the environment.

24. The generator of claim 23, further comprising temperature sensors (28) and a pressure sensor (27) located in said reaction chamber (7).

25. The generator of claim 24 further comprising
heating means (11) for heating said reaction chamber; and
cooling means (12) for cooling said reaction chamber.

26. The generator of claim 25 further comprising a control unit (29) connected to said pressure sensor (27) and said temperature sensors (28), said control unit controlling said pump (5), said heating means and said cooling means.

27. The generator of claim 26 further comprising first liquid level sensors (39, 40) contained within said collecting area (30), said level sensors being controlled by said control unit (29) which control unit also controls said controllable valve (37).

28. The generator of claim 27 further comprising an at least partially heated conduit (36) extending from said exhaust products outlet (32) through said controllable valve (37) to a conduit end (28) located outside of the hydrogen generator.

29. The generator of claim 28 further comprising
a cooling device (14) connected at an entry point to said gas outlet (13);
a gas/liquid separator (19) connected to an exit point of said cooling device;
a second liquid collecting area (45) enclosed within said gas/liquid separator;
second liquid level sensors (47, 48) located within said second liquid collecting area; and
a discharging conduit (46) connected at one end to said second liquid collecting area and at the other end optionally either to said controllable valve (37) or to a point between said container (2) and said pump (5).

30. The generator of claim 29 wherein said controllable valve (37) opens into a container for accumulating said reaction exhaust products (31) which container itself opens into the environment.

31. A method for operating a hydrogen generator comprised of a container (2) of an aqueous solution connected to the input of a pump (5), a reaction chamber (7) connected to the output of the pump, the reaction chamber containing a catalyst (10) temperature sensors (28) and a pressure sensor (27), a first liquid collecting area (30) communicating with the reactor chamber within which are located first liquid level sensors (39, 40), a heating means for heating the reaction chamber, a cooling means for cooling the reaction chamber, a gas outlet (13) connected to the reaction chamber, an exhaust products outlet (32) connected to and exiting from the collecting area and a controllable valve (37) open to the environment connected to said exhaust products outlet, a control unit (29) connected to the pressure and temperature sensors for controlling the operation of the pump, the heating means, the cooling means and the controllable valve comprising:
pumping a quantity of the aqueous solution from the container into the reaction chamber;
awaiting initiation of a catalytic reaction in the reaction chamber;
measuring the pressure at the pressure sensor and the temperature at the temperature sensors; and
adjusting the temperature of the reaction chamber by use of the heating means and the cooling means such that the relationship between the minimum temperature and the pressure is defined by a curve (60) as shown in FIG. 4 herein representing connection of the points in the following table:
Temperature (° C.)

| | 70 | 85 | 100 | 115 |
|---|---|---|---|---|
| Pressure | 100 | 300 | 800 | 1200 |
| (kPa) | | | | |

32. The method of claim 31 wherein the aqueous solution is a 25% sodium borohydride (NaBH4) solution in water (H2O) and the pressure in the reaction chamber (7) is controlled by the pump (5) such that the relationship between the maximum temperature and the pressure is defined by a curve (61) as shown in FIG. 4 herein representing connection of the points in the following table:
Temperature (° C.)

| | 85 | 100 | 115 | 130 |
|---|---|---|---|---|
| Pressure (kPa) | 300 | 550 | 800 | 1050 |

33. The method of claim 31 wherein the aqueous solution is a 20% sodium borohydride (NaBH4) solution in water (H2O) and the pressure in the reaction chamber (7) is controlled by the pump (5) such that the relationship between the maximum temperature and the pressure is defined by a curve (62) as shown in FIG. 4 herein representing connection of the points of the following table:

| | Temperature (° C.) | | | | |
|---|---|---|---|---|---|
| | 70 | 85 | 100 | 115 | 130 |
| Pressure (kPa) | 100 | 150 | 230 | 350 | 500 |

34. The method of claim 31 further comprising opening and closing the controllable valve in intervals controlled by the first liquid level sensors.

35. The method of claim 31 wherein a cooling device (14) is connected at an entry point to the gas outlet, a gas/liquid separator (19) is connected to an exit point of the cooling device, a second liquid collecting area (45) is enclosed within the gas/liquid separator, second liquid level sensors (47, 48) are located within the second liquid collecting area, and a discharging conduit (46) is connected at one end to the second liquid collecting area and at the other end optionally either to the controllable valve or to a point between the container and the pump further comprising opening and closing the controllable valve in intervals controlled by the second liquid level sensors.
